(19) United States
(12) Patent Application Publication
(10) Pub. No.: US 2004/0085338 A1
(43) Pub. Date: May 6, 2004

(54) Automatic index making system and method for electronic catalog

(75) Inventors: Mikihiko Terashima, Hachioji-shi (JP); Takao Shibasaki, Tokyo (JP); Hiroshi Matsuzaki, Hachioji-shi (JP); Yukihito Furuhashi, Hachioji-shi (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, Tokyo (JP)

(21) Appl. No.: 10/695,053

(22) Filed: Oct. 28, 2003

(30) Foreign Application Priority Data
Oct. 30, 2002 (JP) 2002-316102

(51) Int. Cl. G09G 5/00

(52) U.S. Cl. 345/719; 348/231.2

(57) ABSTRACT

An automatic index making system for an electronic catalog comprises an object input section configured to enter an image object which enables generation of at least two or more different images by setting a virtual view point to read an image, a generated image specification section configured to output specified information, and a two-dimensional image generation section configured to electronically analyze the image object entered by the object input section, based on the specified information from the generated image specification section to generate a two-dimensional image. The system further comprises an index data creation section configured to create index data by use of the two-dimensional image generated by the two-dimensional image generation section, and an index output section configured to output an index by use of the index data created by the index data creation section.

### CROSS-REFERENCE TO RELATED APPLICATIONS

This application is based upon and claims the benefit of priority from the prior Japanese Patent Application No. 2002-316102, filed Oct. 30, 2002, the entire contents of which are incorporated herein by reference.

### BACKGROUND OF THE INVENTION

1. Field of the Invention

The present invention relates to a system and a method of making an index for an electronic catalog which contains at least two or more images to be generated by setting a virtual view point to read an image such as a three-dimensional image, a panoramic image or an object all-round image.

2. Description of the Related Art

With regard to a two-dimensional static image, generally, a thumbnail image formed by reducing an image size has been in wide use for an electronic catalog on a WEB or a CD-ROM.

As an object which enables generation of a plurality of images, there is a device which generates different images depending on time. That is, for a dynamic image, for example, as described in Jpn. Pat. Appln. KOKAI Publication No. 5-020367 and U.S. Pat. No. 5,177,513, various devices have been presented which make cuts when scenes are changed, generate thumbnail images for the scenes and automatically make indexes.

### BRIEF SUMMARY OF THE INVENTION

An automatic index making system for an electronic catalog according to a first aspect of the present invention comprises an object input section, a generated image specification section, a two-dimensional image generation section, an index data creation section, and an index output section. The object input section is configured to enter an image object which enables generation of at least two or more different images by setting a virtual view point to read an image. The generated image specification section is configured to output specified information. The two-dimensional image generation section is configured to electronically analyze the image object entered by the object input section, based on the specified information from the generated image specification section to generate a two-dimensional image. The index data creation section is configured to create index data by use of the two-dimensional image generated by the two-dimensional image generation section. The index output section is configured to output an index by use of the index data created by the index data creation section.

In an automatic index making method for an electronic catalog according to a second aspect of the present invention, an image object which enables generation of at least two or more different images by setting a virtual view point to read an image is entered, specified information is output, and the entered image object based on the specified information is electronically analyzed to generate a two-dimensional image. An index data is created by using the generated two-dimensional image, and an index by using the created index data is output.

An automatic index making system for an electronic catalog according to a third aspect of the present invention comprises object input means for entering an image object which enables generation of at least two or more different images by setting a virtual view point to read an image, generated image specification means for outputting specified information, and two-dimensional image generation means for electronically analyzing the image object entered by the object input means, based on the specified information from the generated image specification means to generate a two-dimensional image. The system further comprises index data creation means for creating index data by use of the two-dimensional image generated by the two-dimensional image generation means, and index output means for outputting an index by use of the index data created by the index data creation means.

In the specification, the term “image object” is an object which contains at least two or more images to be generated by setting a virtual view point to read an image such as a three-dimensional image, a panoramic image or an object all-round image. Similarly, the term “two-dimensional image” is a thumbnail image in which one of the plurality of images contained in the image object is reduced. The term “index data” is electronic data which specifies arrangement of the two-dimensional image or an object name in indexes of a bibliography, or a storage address of the object. The term “index” is made such that a plurality of two-dimensional images are arrayed and, in accordance with specification of one two-dimensional image by a user, an image object corresponding to the two-dimensional image can be read.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an automatic index making system for an electronic catalog according to a first embodiment of the present invention;

FIG. 2 is a view showing a two-dimensional image, index data and an index to be made when an image object is a three-dimensional image group of a head including a human face, and specified information is presence of a nose;

FIG. 3 is a view showing a two-dimensional image when an image object is a three-dimensional image of a chair, and specified information is whether or not an object in the image object is a preset spatial posture (upright) in an automatic index making system for an electronic catalog according to a second embodiment of the present invention;

FIG. 4 is a view showing a two-dimensional image when an image object is a three-dimensional image of a portable telephone, and specified information is that a spatial posture is a front of an object in an automatic index making system for an electronic catalog according to a third embodiment of the present invention;

FIG. 5 is a view showing a two-dimensional image when an image object is a three-dimensional image of a portable telephone, specified information is illumination information of the image object, and an object is illuminated from the left lower side in an automatic index making system for an electronic catalog according to a fourth embodiment of the present invention;

FIG. 6 is a view showing a two-dimensional image when an image object is an object all-round image of a camera with a logo (so-called para-para photo), and specified information is easiness of logo interpretation in an automatic index making system for an electronic catalog according to a fifth embodiment of the present invention;

FIG. 7 is a view showing a two-dimensional image when an image object is a three-dimensional image of a portable telephone in which a background varies from one preparer to another, and specified information is that a spatial posture is an upper surface of an object in an automatic index making system for an electronic catalog according to a sixth embodiment of the present invention;

FIG. 8 is a view showing an example of a two-dimensional image when an image object is a three-dimensional image of a portable telephone and a PC mouse (character on the backside), and specified information is that a spatial posture is an upper surface, and easiness of character interpretation in an automatic index making system for an electronic catalog according to a seventh embodiment of the present invention;

FIG. 9 is a view showing examples of a two-dimensional image and an index when an image object is a three-dimensional image of an automobile, specified information is that a spatial posture a front, a backside, a side face and a perspective view, and an image size of the perspective view is largest in an automatic index making system for an electronic catalog according to an eight embodiment of the present invention;

FIG. 10 is a view showing a screen for both an index and searching, the index being made by an automatic index making system for an electronic catalog according to an eleventh embodiment of the present invention; and

FIG. 11 is a view showing a screen of a similar image searching result according to the eleventh embodiment.

### DETAILED DESCRIPTION OF THE INVENTION

Next, the embodiments of the present invention will be described with reference to the accompanying drawings.

[First Embodiment]

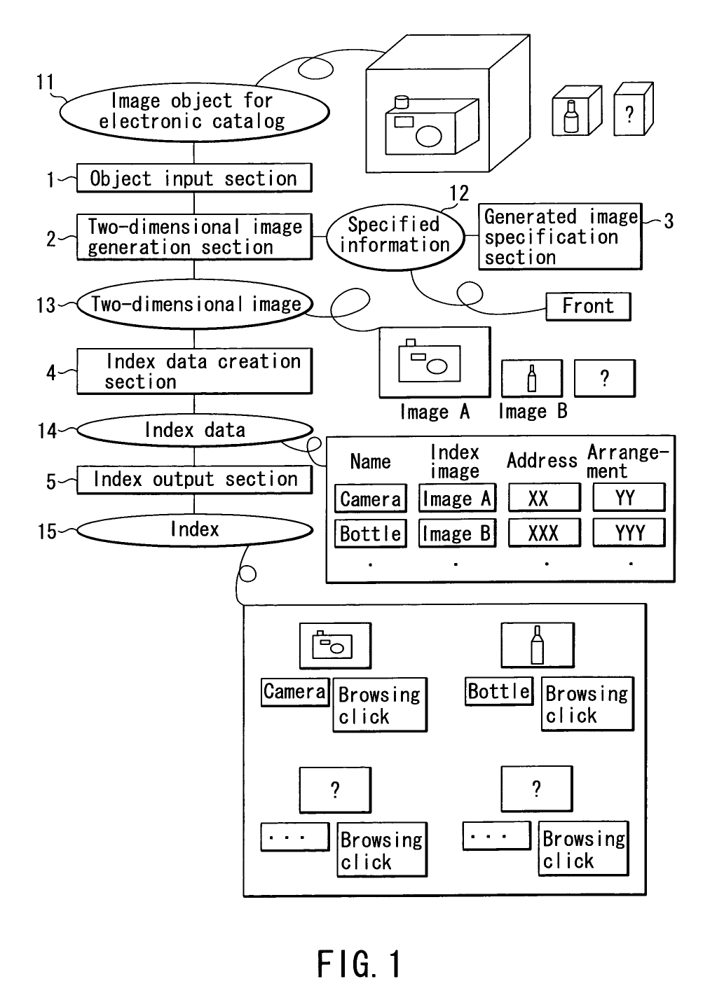

As shown in FIG. 1, an automatic index making system for an electronic catalog according to a first embodiment of the present invention comprises an object input section 1, a two-dimensional image generation section 2, a generated image specification section 3, an index data creation section 4, and an index output section 5.

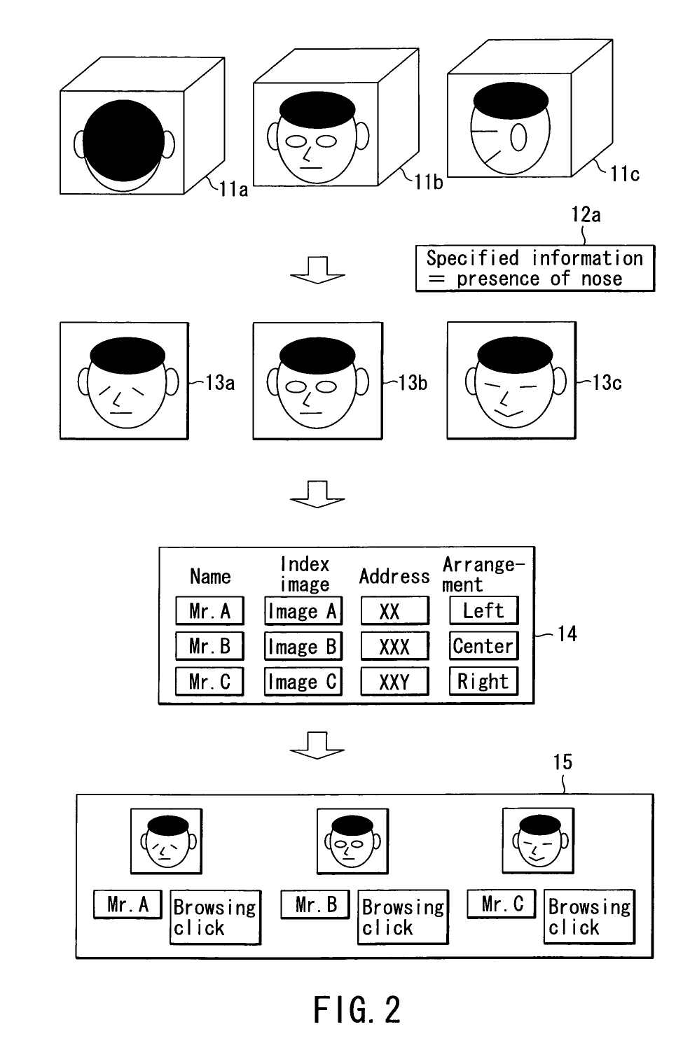

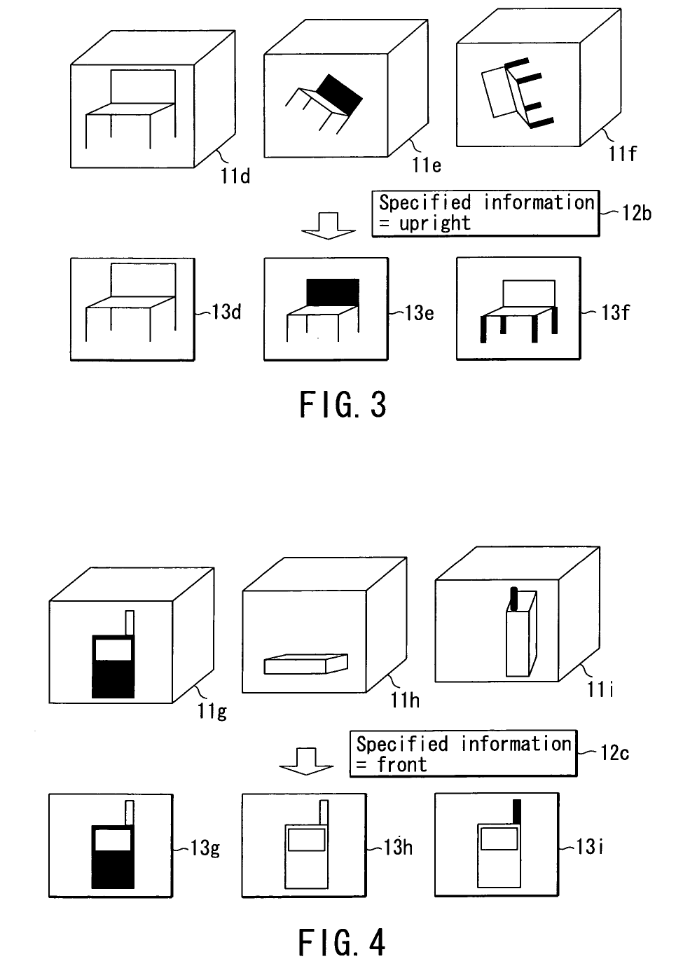

That is, first, the object input section 1 enters an electronic catalog image object 11 to be cataloged, e.g., a three-dimensional image of a head including a human face similar to that shown at the uppermost stage of FIG. 2 (three-dimensional image 11a of Mr. A's head, three-dimensional image 11b of Mr. B's head, three-dimensional image 11c of Mr. C's head, . . . ). This object input section 11 can be constituted of, e.g., a memory reader of a computer.

Next, based on specified information 12 from the generated image specification section 3, the two-dimensional image generation section 2 electronically analyzes the image object 11 entered by the object input section 1 to generate a two-dimensional image 13 (thumbnail image). The specified information 12 may be various information regarding presence of an object or a part of the object represented in the image object 11, and specific characteristics such as a spatial posture, a color and character information in the image object. In an example of FIG. 2, the specified information is “presence of a part (nose) of the object” 12a. This specified information may be described in a program beforehand, or set to be entered by a user who uses means such as a GUI. In the example of FIG. 2, it is described in a program beforehand. The two-dimensional image generation section 2 electronically analyzes, based on the specified information 12, the image object 11 by using a program of a computer or the like to generate a two-dimensional image 13 which matches the conditions of the specified information. Specifically, the example of FIG. 2 comprises a face detection program. The image object 11 is electronically analyzed by using the face detection program to generate a two-dimensional image which contains a nose (Mr. A's two-dimensional image 13a, Mr. B's two-dimensional image 13B, Mr. C's two-dimensional image 13c, . . . ) as shown at a second stage of FIG. 2.

Afterward, the index data creation section 4 creates index data 14 by using the two-dimensional image 13 generated at the two-dimensional image generation section 2. As shown at a third stage of FIG. 2, the index data 14 indicates electronic data which specifies arrangement of a bibliography in an index 15 such as a two-dimensional image (index image) and an object name (title), a storage address of the object, or the like.

Then, the index output section 5 outputs the index 15 similar to that shown at the lowermost stage of FIG. 2 as an electronic catalog index by using the index data 14 created at the index data creation section 4. This index output section 5 is a portion to lastly output the index, which a display, a printer or an electronic file output program is equivalent to. In the example of FIG. 2, the index is displayed on a display.

As described above, according to the embodiment, the three-dimensional image as the image object 11 to be cataloged is entered and, then, based on the specified information 12, i.e., the presence of a part (nose) of the object represented in the three-dimensional image, the three-dimensional image is electronically analyzed to generate the two-dimensional image 13 (front face) which properly represents a content of the image object 11. That is, the automatic index making system for an electronic catalog is achieved, which can automatically generate the proper two-dimensional image 13 (thumbnail image) which can represent the content of the image object 11 to be easily understood.

The specified information 12 is presence information of the object or a part of the object in the image object 11. In the case of an object which has a concept of a view point, the object or a part of the object may not be seen depending on a view point.

If as indication of the object content, the specified information 12 that an object or a part of the object to be represented is always present is set, and the image object 11 is electronically analyzed to generate a two-dimensional image, the object or a part of the object is always present in the two-dimensional image which becomes the index 15. Thus, it is possible to automatically generate a two-dimensional image (thumbnail image) which can represent the object content much better.

The sections in the embodiment and the arithmetic operation portions which constitute the sections may all use dedicated processors, or calculations may be made by a CPU which reads programs. According to the embodiment, the image object 11 is a three-dimensional image. However, any image objects may be used as long as a plurality of different images by setting virtual view points to read images, such as a panoramic image, and an object all-round image which has no shape data to be strict. Additionally, according to the embodiment, the specified information 12 is described in the program beforehand. However, the user may specify “there is a nose”, “there is an eye”, “upper surface direction”, “perspective view”, “character can be determined” or the like on the GUI.

The components of the embodiment are all similarly employed in the following embodiments.

[Second Embodiment]

According to the embodiment, an image object 11 is a three-dimensional image (three-dimensional image 11d of a chair A, three-dimensional image 11e of a chair B, three-dimensional image 11f of a chair C, . . . ), and specified information 12 indicates whether or not an object in the image object 11 is a preset spatial posture (“upright 12b”). In this case, as a method of analysis at a two-dimensional image generation section 2, for example, a program is provided to recognize a leg direction of the chair, whether or not the chair is upright is electronically analyzed, and a two-dimensional image 13 of an upright chair (two-dimensional image 13d of a chair A, two-dimensional image 13e of a chair B, two-dimensional image 13f of a chair C, . . . ) is generated so that the chair can be represented based on a vertical direction in which it should be present in a real world.

In the case of an image object such as a chair which has a concept of a view point, preferably, for a two-dimensional image used for an index, an object is represented based on a vertical direction in which it should be present in a real world (e.g., a leg of the chair is directed vertically downward). However, in the case of an image object which has a concept of a free view point, a view point or an origin may be frequently different depending on a preparer of the image object. Thus, whether or not the object in the image object 11 is a preset spatial posture is electronically analyzed, and a two-dimensional image 13 is generated in alignment with another so that, for example, the object can be represented based on a vertical direction in which it should be present in a real world. Thus, since the two-dimensional image 13 can be generated so that the object can be present in the real world, it is possible to automatically generate a proper two-dimensional image (thumbnail image) which can represent an image object content much better.

Needless to say, there may be a case in which the object can be made more understandable by daringly representing a posture nonpresent in the real world (backside of the chair or backside of an automobile is seen). In this case, a spatial posture as the specified information 12 may be properly set to realize such a constitution.

As an index, aligned postures of a plurality of image objects provide an effect of easier viewing. By instructing alignment of spatial postures of all the image objects, it is possible to make a simple and easily seen index.

[Third Embodiment]

According to the embodiment, an image object 11 is a three-dimensional image of a portable telephone similar to that shown in FIG. 4 (three-dimensional image 11g of a portable telephone A, three-dimensional image 11h of a portable telephone B, three-dimensional image 11i of a portable telephone C, . . . ), and a spatial posture specified as specified information 12 is a “front of an object” 12c.

That is, a view point from the front of the portable telephone is understandable. Thus, by setting a direction of the front which is understandable to a user, a generated two-dimensional image 13 for an index (two-dimensional image 13g of a portable telephone A, two-dimensional image 13h of a portable telephone B, two-dimensional image 13i of a portable telephone C, . . . ) also becomes intuitively understandable. If data origins are aligned beforehand when the image object 11 is electronically analyzed, it has an advantage of enabling very easy generation of a two-dimensional image without any need to analyze a structure of the object in detail.

The spatial posture specified as the specified information 12 is not limited to the “front of the object” 12c. It may be an upper surface, a side face, and/or a perspective surface of the object. That is, in a design drawing or the like, a spatial posture which represents a target is generally a front, an upper surface, a side face or a perspective surface of an object. Thus, a direction understandable to the user may be set.

[Fourth Embodiment]

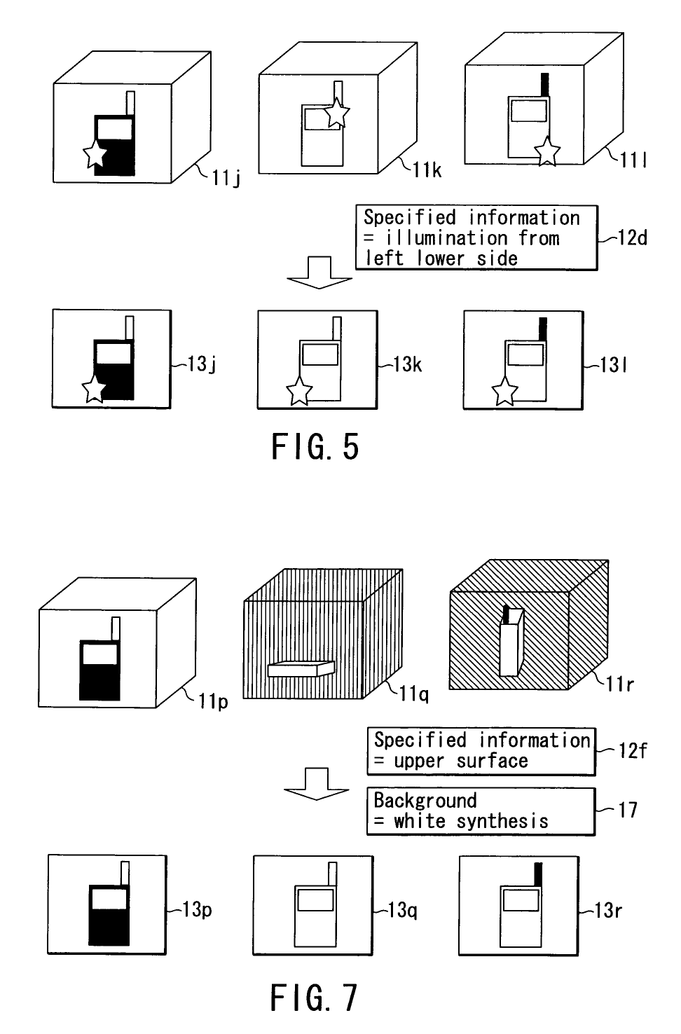

According to the embodiment, an image object 11 is a three-dimensional image of a portable telephone similar to that shown in FIG. 5 (three-dimensional image 11j of a portable telephone A, three-dimensional image 11k of a portable telephone B, three-dimensional image 11l of a portable telephone C, . . . ), and specified information 12 is “object is illuminated from a left lower side” 12d as illumination information of the image object 11.

In this case, as a method of analysis at a two-dimensional image generation section 2, for example, a two-dimensional image 13 in which an object is illuminated from the left lower side (two-dimensional image 13j of a portable telephone A, two-dimensional image 13k of a portable telephone B, two-dimensional image 13l of a portable telephone C, . . . ) is generated by searching a reflection place as a halation spot, reading an illumination direction described in a file, etc.

Thus, since the two-dimensional image 13 illuminated from a certain desired direction (left lower side) can be generated, it is possible to automatically generate a proper two-dimensional image (thumbnail image) in which not only all the objects are illuminated from a specified direction to make the index understandable but also a texture of each object is emphasized to represent the object content much better.

The illumination information may be, for example, a color of an illumination light or a kind of an illumination light in addition to the direction of the illumination light such as “object is illuminated from left lower side” 12d. In the case of an object which has a concept of a view point, how the object is seen frequently changes greatly depending on the illumination information. Thus, by specifying the illumination information regarding the image object 11, it is possible to specify a desired way the object is seen. For example, if all bits of illumination information are set in the same direction, all-aligned reflection representation is realized to enable automatic generation of a proper two-dimensional image which can represent the object content much better.

[Fifth Embodiment]

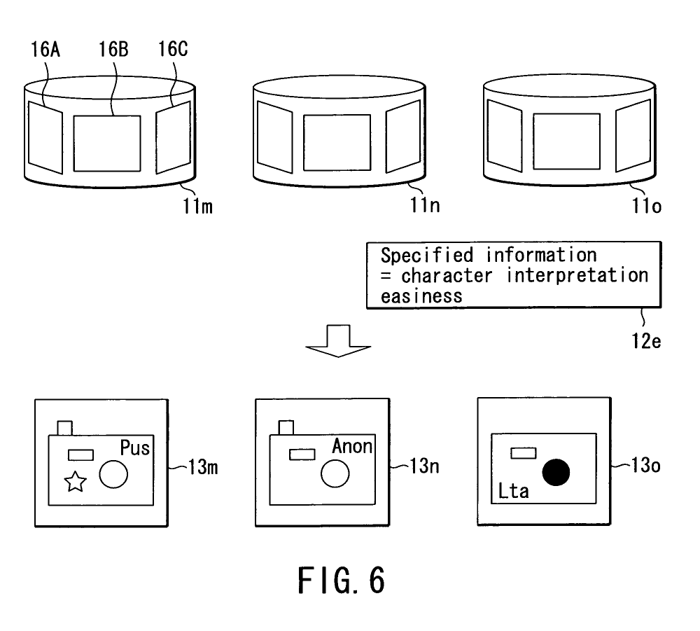

According to the embodiment, as shown in FIG. 6, an image object 11 is an object all-round image similar to a so-called para-para photo which contains an image 16A slightly from a left, a front image 16B, an image 16C slightly from a right, an image slightly more from the right, . . . (all-round image 11m of a cameral A with a logo, all-round image 11n of a cameral B with a logo, all-round image 11o of a camera C with a logo, . . . ), and specified information 12 is an “interpretation easiness of logo” 12e.

In this case, as a method of analysis at a two-dimensional image generation section 2, a character recognition program is provided to electronically analyze whether or not a logo can be determined, whereby a two-dimensional image 13 which enables reading of the logo (two-dimensional image 13m of a camera A with a logo, two-dimensional image 13n of a camera B with a logo, two-dimensional image 13o of a camera C, . . . ) can be generated.

According to the embodiment, it is possible to make an index for a two-dimensional image (thumbnail image) with a logo which represents an object content (camera) much better.

If character information is contained in an object, and the character has important implications, preferably, the character is contained in the two-dimensional image 13 for the index (logo of a maker, a signboard, a note of caution or the like). Thus, according to the embodiment, by setting interpretation easiness of the character as specified information 12, a two-dimensional image for an index is always present to enable reading of a character in an object. As a result, it is possible to automatically generate a proper two-dimensional image (thumbnail image) which can represent an object content much better.

[Sixth Embodiment]

According to the embodiment, as shown in FIG. 7, an image object 11 is a three-dimensional image of a portable telephone in which a background varies from one preparer to another (three-dimensional image 11p of portable telephone A, three-dimensional image 11q of a portable telephone B, three-dimensional image 11r of a portable telephone C), and a spatial posture set as specified information 12 is an “upper surface of an object” 12f. At a two-dimensional image generation section 2, a unified background is synthesized in accordance with background setting (“white synthesis” 17 in an example of FIG. 7) when a two-dimensional image 13 (two-dimensional image 13p of a portable telephone A, two-dimensional image 13q of a portable telephone B, two-dimensional image 13r of a portable telephone C, . . . ) is generated.

An object background is generally different from one preparer to another, or flat plain. Accordingly, at the two-dimensional image generation section 2, proper backgrounds are synthesized. Backgrounds to be synthesized may be unified in an index, or special backgrounds may be synthesized to enable better representation of each object. In this case, a background to be set can be specified by an operator. Alternatively, a background may be selected in an object bibliography which is separately set beforehand, or a proper background may be selected by setting a certain yardstick and carrying out electronic analysis. Synthesis of such backgrounds creates an easily seen index which is unified among objects.

Needless to say, not only the backgrounds are synthesized for the two-dimensional image (thumbnail image) as described above, but also backgrounds may be synthesized for original object data or its copy data. The copy data is made a target for background synthesis because there may be a case in which the original data cannot be corrected.

[Seventh Embodiment]

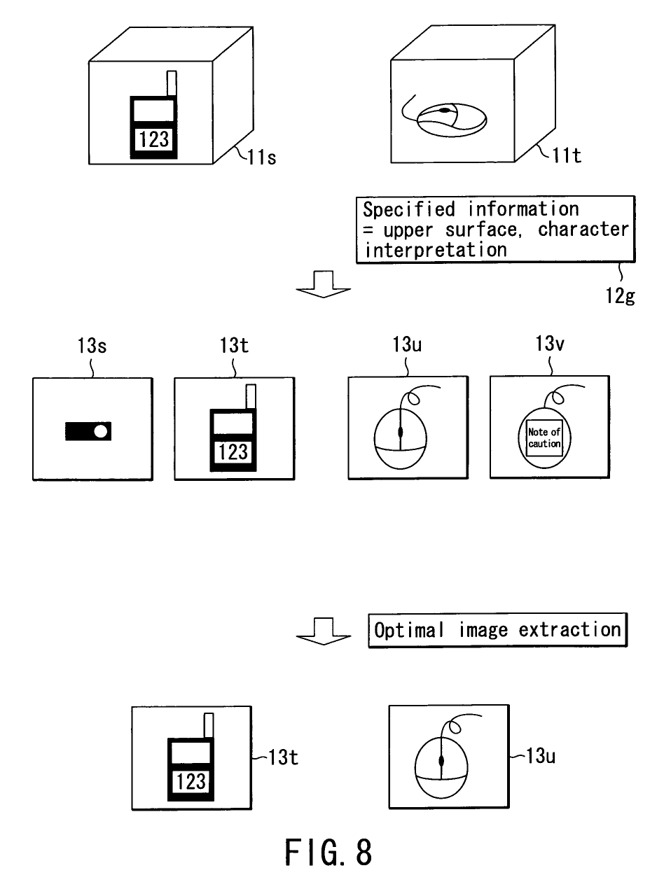

According to the embodiment, as shown in FIG. 8, an image object 11 is constituted of a three-dimensional image 11s of a portable telephone and a three-dimensional image 11t of a PC mouse (there is a character on the backside) and, for specified information 12, a spatial posture is “upper surface and character interpretation easiness” 12g.

In this case, at a two-dimensional image generation section 2, a plurality of two-dimensional images 13 are generated for each image object 11 in accordance with the specified information 12. That is, in an example of FIG. 8, for the three-dimensional image 11s of the portable telephone, a two-dimensional image 13s and a two-dimensional image 13t are generated respectively in accordance with the specification of the upper surface and the specification of the character interpretation easiness. For the three-dimensional image 11t of the PC mouse, a two-dimensional image 13u and a two-dimensional image 13v are generated respectively in accordance with the specification of the upper surface and the specification of the character interpretation easiness.

An index data creation section 4 extracts an optimal two-dimensional image therefrom to use it as index data 14. That is, priority is given to the two-dimensional image 13t selected by the character in the portable telephone, while the two-dimensional image 13u of the upper surface is extracted in the MC mouse.

For selection of such an optimal two-dimensional image 13, an image may be selected in an object bibliography which is separately set beforehand, or a certain yardstick may be set to select an optimal image by electronic analysis. Here, the image is selected in the bibliography (e.g., object name).

Thus, the number of two-dimensional images 13 formed in accordance with the specified information 12 is not limited to one per image object 11. Numerous bits of information (e.g., a spatial posture, presence of a part of an object, etc.) may be specified, or a range may be set in information (e.g., visual line angle 10° to 30°) to create a plurality of two-dimensional data. Then, at the index data creation section 4, one of the two-dimensional images is extracted to be used as index data 14. If there are many kinds of image objects 11, since the specified information 12 which can best represent the content may vary, a plurality of two-dimensional images (thumbnail image) are first generated, and then an optimal image is extracted to make an index. The generation of the plurality of thumbnail images has an advantage of enabling easy simultaneous formation of indexes in accordance with the purpose of use such as an index from the front of the object and an index from the backside of the object.

[Eighth Embodiment]

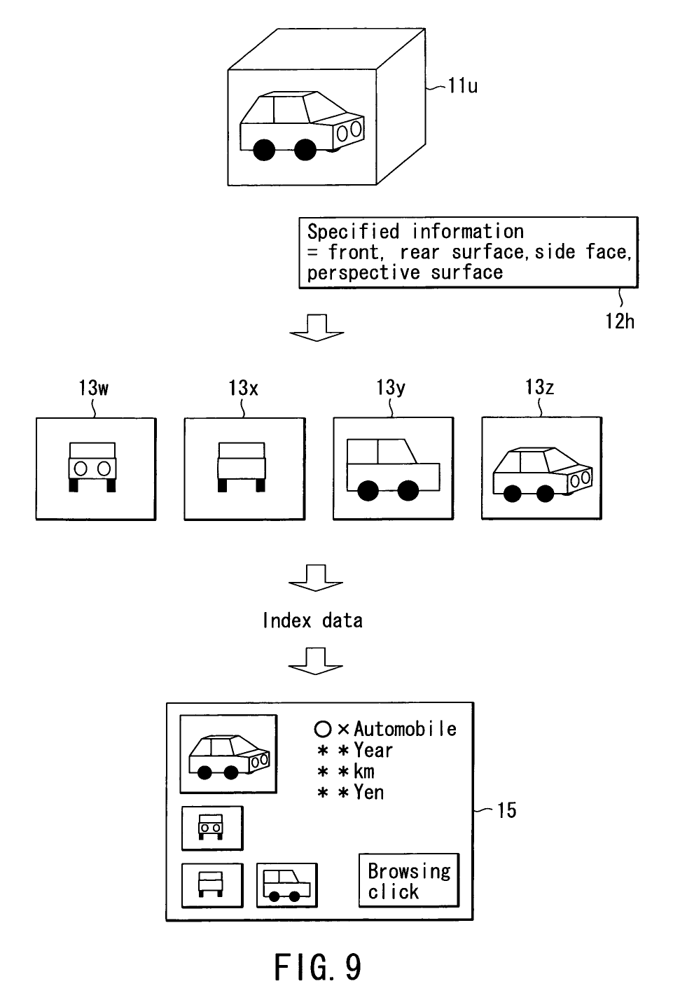

According to the embodiment, as shown in FIG. 9, an image object 11 is a three-dimensional image 11u of an automobile, and specified information 12 is an example in which a spatial posture is “front, rear surface, side face, and perspective view” 12h, and an image size of the perspective view is largest.

In this case, a two-dimensional image generation section 2 generates a plurality of different two-dimensional images 13 from one image object 13 in accordance with the specified information 12, i.e., a two-dimensional image 13w of an automobile from the front, a two-dimensional image 13x of an automobile from the rear face, a two-dimensional image 13y of an automobile from the side face, and a two-dimensional image 13z of an automobile as a perspective view. That is, at the two-dimensional image generation section 2, at least two or more different two-dimensional images are generated for one image object 11. At an index data creation section 4, index data 14 which has at least two or more two-dimensional images is created for one image object 11. The presence of the plurality of two-dimensional images (thumbnail images) which become indexes for one image object has an advantage of realizing indexes to be easily understood by a user. For example, if by changing view points, two-dimensional images of a front, an upper surface, a side face and a perspective view to be used as index data, the indexes may be understood more easily by the user.

Thus, according to the embodiment, it is possible to automatically generate an index 15 having a two-dimensional image (thumbnail image) which can efficiently use an area by representing the object from a number of view points and reflecting object information more.

At the two-dimensional image generation section 2, index data is created in which at least one display image size is different among the two-dimensional images in the index data 14. For example, the generation of two-dimensional images of a front, an upper surface, a side face and a perspective view has advantages of enabling not only efficient use of the area and but also easier viewing by the user if the display image size of the perspective view is set large while other surfaces are small, and the index 15 is lastly outputted on a display screen or paper.

[Ninth Embodiment]

According to the embodiment, image objects 11 of various types of formats are entered, and specified information 12 is an example in which all are corrected to VRML formats.

Such correction has an advantage of enabling generation of an electronic catalog in which formats are aligned and subsequent editing becomes easier.

That is, at a two-dimensional image generation section 2, the image object 11 is electronically analyzed, and at least data of one of the image object 11 or a copy of the image object 11 is corrected. At the two-dimensional image generation section 2, the image object 11 is electronically analyzed, but the image object 11 is entered. Thus, it is possible to simultaneously obtain information to be corrected when the image object is stored for an electronic catalog. The content of electronic analysis is not limited to analysis based on the specified information 12, but analysis may be based on other kinds of items such as a data capacity or a format. Correction of the data capacity, the format, an luminance level for good screen displaying or virtual illumination conditions has an advantage of enabling generation of an electronic catalog to be seen and used more easily. A copy of the image object 11 is also a target for correction in addition to the image object 11. It is because there is a case in which original data cannot be corrected.

[Tenth Embodiment]

According to the embodiment, three-dimensional images in which initial spatial positions are different are entered for an image object 11, all are corrected to be in the same position for specified information 12, and emission coefficients of objects are corrected to be equal.

Three-dimensional images are generally different in screens to be first displayed and object emission coefficients depending on a preparer and forming means. However, by the unified correction, not only an index can be easily seen but also the object can be simultaneously seen very easily when a catalog indicated by the index is read.

The target for correction can be at least one selected from a space origin coordinate of the image object, inclination of a space coordinate axis, a luminance value, a color, a coefficient of reflection, an object emission coefficient, the number of polygons, an initial spatial position, and object illumination conditions. In the case of the three-dimensional image, there are many description parameters, which frequently vary greatly from one preparer to another. Thus, if the catalog is displayed in this state, reading becomes very difficult depending on an object because there is large variance in brightness, direction and size. The followings are possible problems: a space origin coordinate (center of the object is shifted); inclination of a space coordinate axis (inclination of the object is shifted); a luminance value (light and shade of the object are changed); a color (color of the object is changed); a coefficient of reflection (reflected light of the object is changed); an object emission coefficient (brightness of the object is changed); the number of polygons (shape roughness of the object is changed); and an initial spatial position (first display is changed).

According to the embodiment, the correction of the aforementioned parameters for the object or its copy in the three-dimensional image has an advantage of enabling formation of an electronic catalog to be seen and used more easily.

[Eleventh Embodiment]

According to the embodiment, a two-dimensional image generation section 2 further comprises a function of generating a two-dimensional image 13 and detecting a characteristic amount of the generated two-dimensional image 13. An index output section 5 further has a function of electronically searching a similar image object of an image object 11 by using the characteristic amount of the two-dimensional image 13 detected at the two-dimensional image generation section 2.

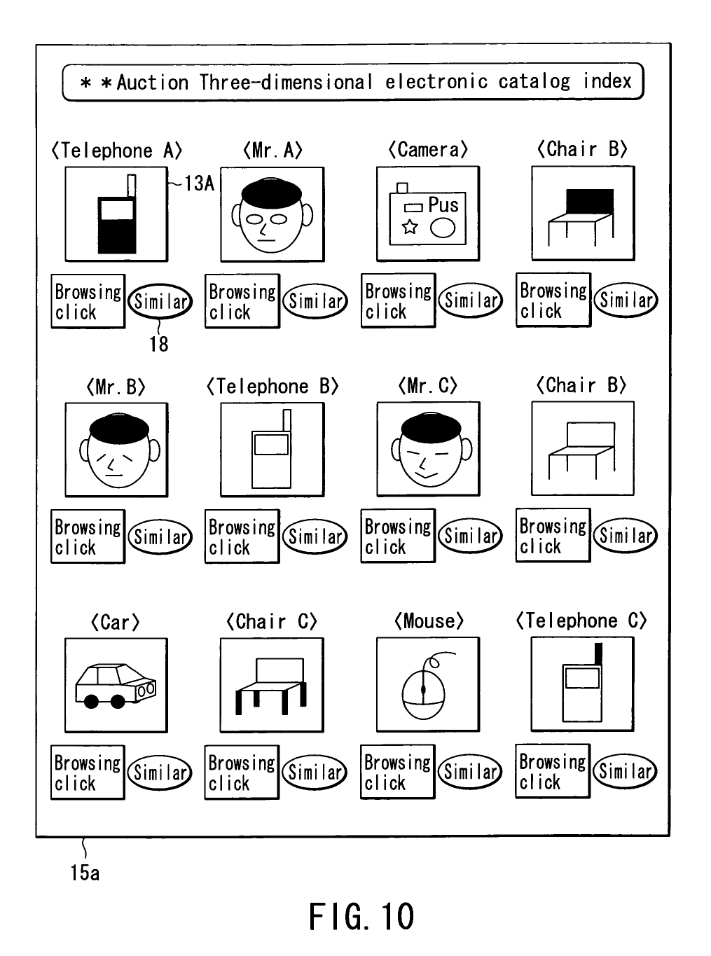

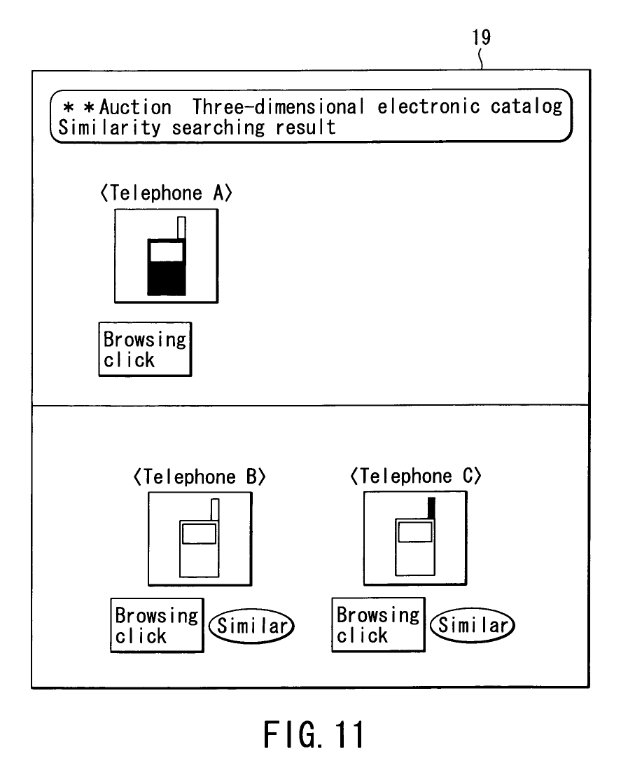

By such a configuration, the index output section 15 can output an index screen 15a similar to that shown in FIG. 10, and a screen 19 of a similar image searching result similar to that shown in FIG. 11 by, for example, searching a similar image object which has a characteristic amount comparable to a characteristic amount of a two-dimensional image 13A of a telephone A in accordance with a mouse clicking operation of a “similar” button 18 arranged near the two-dimensional image 13A of the “telephone A”.

The index screen 15a outputted by the index output section 5 can be used not only for a normal indexing operation but also as a search screen for electronically searching the similar image object. That is, it can be used as a screen for both indexing and searching.

Moreover, the searching operation itself of the similar image object is carried out by using the characteristic amount of the two-dimensional image 13 generated at the two-dimensional image generation section 2. As described thus far, the two-dimensional image 13 generated at the two-dimensional image generation section 2 is an image which represents the content of the image object 11 to be easily understood. Thus, the electronic searching carried out by using the characteristic amount of the two-dimensional image has an advantage of enabling more accurate searching of a similar image object.

[Twelfth Embodiment]

According to the embodiment, an index output section 5 outputs the index 15 as a paper medium.

Generally, in the case of an image object for generating a plurality of images such as a three-dimensional image, a panoramic image and an object all-round image, it is difficult to output the object itself by a real medium such as paper or a model because of its nature. As described thus far, the index 15 generated by the invention represents the object to be understood very easily. Thus, if the object is simultaneously outputted as a paper medium, an advantage is provided in which even in a situation of impossible electronic reading of an index or a catalog due to “no PC”, “network failure” or the like, an object content can be understood which is comparable to electronic reading of the object itself.

The present invention has been described by way of embodiments. Needless to say, however, the invention is not limited to the embodiments, and various changes and applications are possible within the scope of the teachings of the invention.

For example, by incorporating the system of the invention in an image search system and fetching an image, a search database system and an index may be simultaneously generated.

The image object 11 which enables the formation of at least two different images by setting a virtual view point to read an image entered in the present invention needs no generation of the images purposely, if the image object 11 has a plurality of images based on a concept of a view point. For example, it needs not be completed three-dimensional data. It may be certain partial data, a photo group in which an axis is shifted in a so-called para-para photo (e.g., a group of photos which the user has taken by properly shifting positions), or an image group in which the user has taken and stored a plurality of images considered necessary for a certain object. Alternatively, it may be a map image formed based on data from many view points (irrespective of two-dimensional or three-dimensional images).

For the specified information, it may range from a high level in which the analysis is accompanied by an image recognition program to a level in which determination is made by reading information electronically or artificially added to an image, such as an image size, a format, an image name, photographing time, or a photographing place or presence of object flaws. Since the determination made by reading such information added to the image enables specification of not only information in the image but also added information (format information, date information, a file name or the like), it is possible to generate a two-dimensional image which represents characteristics of the object much better.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An automatic index making system for an electronic catalog, comprising:
an object input section configured to enter an image object which enables generation of at least two or more different images by setting a virtual view point to read an image;
a generated image specification section configured to output specified information;
a two-dimensional image generation section configured to electronically analyze the image object entered by the object input section, based on the specified information from the generated image specification section to generate a two-dimensional image;
an index data creation section configured to create index data by use of the two-dimensional image generated by the two-dimensional image generation section; and
an index output section configured to output an index by use of the index data created by the index data creation section.

2. The apparatus according to claim 1, wherein the specified information includes presence information of one of an object in the image object and a part of the object.

3. The apparatus according to claim 1, wherein the specified information includes whether or not an object in the image object is a preset spatial posture.

4. The apparatus according to claim 3, wherein the spatial posture includes at least one of a front, an upper surface, a side face and a perspective surface of the object.

5. The apparatus according to claim 1, wherein the specified information includes illumination information of the image object.

6. The apparatus according to claim 1, wherein
the object has character information, and
the specified information includes interpretation easiness of the character.

7. The apparatus according to claim 1, wherein the two-dimensional image generation section includes a function of synthesizing a background.

8. The apparatus according to claim 1, wherein
the two-dimensional image generation section generates at least two or more different two-dimensional images for one of the image objects, and
the index data creation section extracts one of the different two-dimensional images to use it as index data.

9. The apparatus according to claim 1, wherein
the two-dimensional image generation section generates at least two or more different two-dimensional images for one of the image objects, and
the index data creation section creates index data corresponding to the at least two or more different two-dimensional images for one of the image objects.

10. The apparatus according to claim 9, wherein at least one display image size is different among the two-dimensional images in the index data.

11. The apparatus according to claim 1, wherein the two-dimensional image generation section includes a function of correcting data of at least one of the image object and a copy of the image object based on a result of electronically analyzing the image object.

12. The apparatus according to claim 1, wherein
the image object is a three-dimensional image, and
a target of the correction includes at least one of a spatial origin coordinate of the image object, inclination of a spatial coordinate axis, a luminance value, a color, a coefficient of reflection, a light emission coefficient of the object, the number of polygons, an initial spatial position, and illumination conditions of the object.

13. The apparatus according to claim 1, wherein the index output section further includes a function of electronically searching an image object similar to the image object.

14. The apparatus according to clam 1, wherein the index output section searches the similar image object by using a characteristic amount of the two-dimensional image generated at the two-dimensional image generation section.

15. The apparatus according to claim 1, wherein the index output section includes a function of outputting the index as a paper medium.

16. The apparatus according to claim 1, wherein the two-dimensional image generation section uses a recognition algorithm to recognize specific characteristics in the image object to electronically analyze the image object entered by the object input section.

17. The apparatus according to claim 1, wherein the two-dimensional image generation section uses an algorithm to read and analyze information added to the image object entered by the object input section to electronically analyze the image object.

18. An automatic index making method for an electronic catalog, comprising:
entering an image object which enables generation of at least two or more different images by setting a virtual view point to read an image;
outputting specified information;
electronically analyzing the entered image object based on the specified information to generate a two-dimensional image;
creating index data by using the generated two-dimensional image; and
outputting an index by using the created index data.

19. An automatic index making system for an electronic catalog, comprising:
object input means for entering an image object which enables generation of at least two or more different images by setting a virtual view point to read an image;
generated image specification means for outputting specified information;
two-dimensional image generation means for electronically analyzing the image object entered by the object input means, based on the specified information from the generated image specification means to generate a two-dimensional image;
index data creation means for creating index data by use of the two-dimensional image generated by the two-dimensional image generation means; and
index output means for outputting an index by use of the index data created by the index data creation means.
